(19) United States
(12) Patent Application Publication
(10) Pub. No.: US 2026/0346835 A1
(43) Pub. Date: Nov. 5, 2026

(54) VEHICLE CONTROL METHOD AND VEHICLE CONTROL DEVICE

(71) Applicant: Panasonic Automotive Systems Co., Ltd., Kanagawa (JP)

(72) Inventor: Tetsuro TODA, Kanagawa Ken (JP)

(73) Assignee: Panasonic Automotive Systems Co., Ltd., Kanagawa (JP)

(21) Appl. No.: 19/719,815

(22) Filed: Jun. 25, 2026

Related U.S. Application Data
(63) Continuation of application No. PCT/JP2024/042392, filed on Nov. 29, 2024.

(30) Foreign Application Priority Data
Dec. 27, 2023 (JP) 2023-220435

(51) Int. Cl. B60W 30/06; B60R 1/27; B60W 10/20

(52) U.S. Cl. CPC B60W 30/06; B60R 1/27; B60W 10/20; B60R 2300/105; B60R 2300/806; B60W 2556/10

(57) ABSTRACT

A vehicle control device is mounted on a vehicle including: a camera; a display device; and a movement control device, and configured to cause the movement control device to control at least steering along a teacher route obtained by teacher traveling from a predetermined position to a parking target position, and cause the vehicle to autonomously travel to the parking target position. The vehicle control device is configured to: display, on the display device, a video of surroundings acquired by the camera; and display, on the display device, a returnable position where returning to the teacher route is possible, the returnable position being superimposed on the video of the surroundings, in a case where the vehicle is a first predetermined distance or more away from the teacher route while the vehicle is moving from the predetermined position to the parking target position along the teacher route.

### CROSS-REFERENCE TO RELATED APPLICATIONS

This application is a continuation of International Application No. PCT/JP2024/042392, filed on Nov. 29, 2024 which claims the benefit of priority of the prior Japanese Patent Application No. 2023-220435, filed on Dec. 27, 2023, the entire contents of which are incorporated herein by reference.

### FIELD

The present disclosure relates to a vehicle control method and a vehicle control device.

### BACKGROUND

In general, there are many narrow parking spaces at a house, and it may be difficult to park the vehicle. Therefore, there is a high need to perform parking and getting a vehicle out of the shed by automatic driving.

A vehicle control device that realizes this type of automatic driving is known. For example, a technique is disclosed in which a vehicle is caused to travel from a predetermined position outside a parking area to a parking target position by a driving operation by a driver, a movement route at the time is stored in advance as a teacher route, and the vehicle is caused to autonomously travel along the teacher route in a parking scene after that (see JP 2017-138664 A, JP 2022-133181 A, US 2014/0200802 A, and JP 2022-133230 A).

However, in the related art, when the vehicle moves away from the teacher route due to, for example, a manual operation for avoiding an obstacle during autonomous traveling along the teacher route, a pre-registered feature point around the vehicle, the feature point being necessary for traveling along the teacher route, and a feature point that can be actually identified do not match, and it may be difficult to resume or continue autonomous traveling. That is, in the prior art, it may be difficult to provide suitable parking assistance.

### SUMMARY

A vehicle control method according to the present disclosure is executed by a vehicle control device mounted on a vehicle including: a camera configured to acquire a video of surroundings, a display device configured to be visually recognized by an occupant, and a movement control device configured to control at least steering. The method includes: causing the movement control device to control at least steering to cause the vehicle to autonomously travel to a parking target position along a teacher route obtained by teacher traveling from a predetermined position to the parking target position; displaying, on the display device, the video of the surroundings acquired by the camera; and displaying, on the display device, a returnable position where returning to the teacher route is possible, the returnable position being superimposed on the video of the surroundings, in a case where the vehicle is a first predetermined distance or more away from the teacher route while moving from the predetermined position to the parking target position along the teacher route.

### BRIEF DESCRIPTION OF THE DRAWINGS

FIG. 1 is a block diagram illustrating an example of an overall configuration of a vehicle;

FIG. 2 is an explanatory diagram of an example of arrangement of a sensor and a camera;

FIG. 3 is a schematic diagram illustrating an example of a configuration of an external appearance of a vehicle;

FIG. 4 is a diagram illustrating an example of a configuration in the vicinity of a driver seat of the vehicle according to the embodiment;

FIG. 5 is an explanatory diagram of an example of a teacher route;

FIG. 6 is a diagram illustrating an example of a data configuration of teacher route data;

FIG. 7A is a schematic diagram of an example of map data;

FIG. 7B is a schematic diagram of an example of map data;

FIG. 8 is an explanatory diagram of an example of an estimation process of a current position of a vehicle, the estimation process being executed by a control unit in an autonomous traveling mode;

FIG. 9 is a schematic diagram of an example of a display screen;

FIG. 10 is a flowchart illustrating an example of a flow of information processing executed by a control unit in a teacher traveling mode;

FIG. 11 is a flowchart illustrating an example of a flow of information processing executed by the control unit in an autonomous traveling mode; and

FIG. 12 is a block diagram illustrating a hardware configuration example of a vehicle control device.

### DETAILED DESCRIPTION

Hereinafter, embodiments of a vehicle control method and a vehicle control device according to the present disclosure will be described with reference to the drawings.

### Overall Configuration of Vehicle

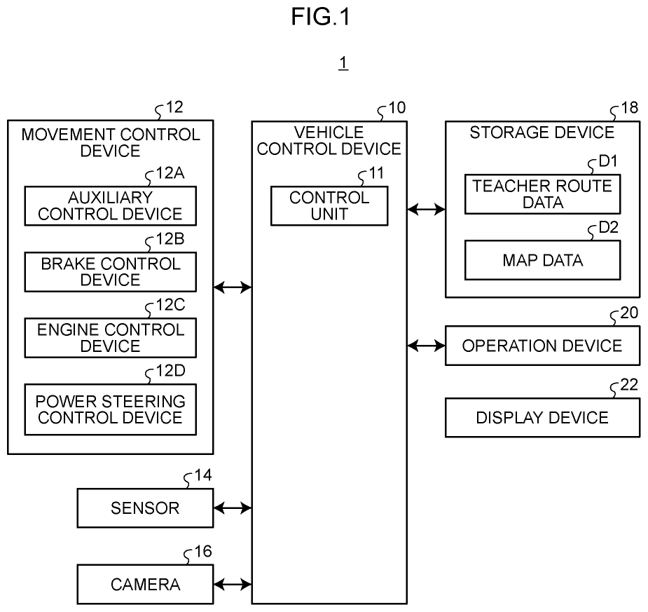

FIG. 1 is a block diagram illustrating an example of an overall configuration of a vehicle 1.

The vehicle 1 includes a vehicle control device 10, a movement control device 12, a sensor 14, a camera 16, a storage device 18, an operation device 20, and a display device 22.

The movement control device 12, the sensor 14, the camera 16, the storage device 18, the operation device 20, and the display device 22 are connected to the vehicle control device 10 so as to be able to exchange data or signals. That is, the vehicle control device 10 is set to be communicably connected to at least the display device 22 and the movement control device 12.

The movement control device 12 controls at least steering of the vehicle 1. The movement control device 12 is a unit that realizes driving, braking, and turning motions necessary for traveling of the vehicle 1. For example, the movement control device 12 includes a drive motor, a power transmission mechanism, a brake device, a steering device, and the like, and an electronic vehicle control device that controls the drive motor, the power transmission mechanism, the brake device, the steering device, and the like. The movement control device 12 causes the vehicle 1 to travel by, for example, generating power with a drive motor and transmitting the power to wheels via a power transmission mechanism. The power transmission mechanism is, for example, a propeller shaft, a differential gear, a drive shaft, or the like.

Specifically, the movement control device 12 includes an auxiliary control device 12A, a brake control device 12B, an engine control device 12C, and a power steering control device 12D. The brake control device 12B, the engine control device 12C, and the power steering control device 12D can be collectively referred to as an actuator control unit that controls the operation of a vehicle 1B.

The auxiliary control device 12A is a control device that monitors the transmission state of the vehicle control device 10 and operates to execute appropriate degeneration control as a backup when the vehicle control device 10 fails. Note that even in a case where the vehicle control device 10 fails, when safety can be secured by providing a degeneration control function in the vehicle control device 10, the degeneration control is unnecessary.

The brake control device 12B is a control device that performs brake control (braking force control) of the vehicle 1. For example, the brake control device 12B performs brake control of the vehicle 1 in accordance with enhancement (depression) and relaxation of the operation of the brake pedal (brake operation unit) by the occupant. Furthermore, the brake control device 12B performs brake control according to the video of the surroundings during autonomous traveling.

The engine control device 12C is a control device that controls an engine that generates a driving force of the vehicle 1. The power steering control device 12D is a control device that controls power steering of the vehicle 1.

The sensors 14 are various sensors that are mounted on the vehicle 1 and detect a traveling state of the vehicle 1 and a state around the vehicle 1. The sensor 14 includes, for example, an accelerator opening sensor that detects an accelerator opening, a steering angle sensor that detects a steering angle of a steering device, an acceleration sensor that detects acceleration acting in the front-rear direction of the vehicle 1, a torque sensor that detects torque acting on a power transmission mechanism between wheels of the vehicle 1 and a drive motor, a vehicle speed sensor that detects a vehicle speed of the vehicle 1, a wheel speed sensor, and the like. Furthermore, the sensor 14 includes a light detection and ranging (LiDAR), a radar, an ultrasonic sensor, or the like. The sensor 14 outputs sensor information obtained by the detection to the vehicle control device 10.

The camera 16 is a surrounding sensor that is mounted on the vehicle 1 and monitors the environment around the vehicle 1. In the present embodiment, the camera 16 captures an image of the surroundings of the vehicle 1, and sequentially outputs the captured image to the vehicle control device 10. In the present embodiment, the camera 16 outputs, to the vehicle control device 10, a video of the surroundings including a plurality of captured images along a time series, the captured images being obtained by capturing the image of the surroundings of the vehicle 1 along the time series. Furthermore, in the present embodiment, the camera 16 is applied to an application of detecting an object around the vehicle 1 and estimating the position of the vehicle 1 from the positional relationship between the vehicle 1 and the object present around the vehicle 1.

The position, the number of installations, and the imaging direction of the camera 16 are adjusted in advance so that the surroundings of the vehicle 1 can be imaged. For example, the vehicle 1 is provided with four cameras 16 disposed so as to be able to capture images in four directions of a front direction, a rear direction, a left direction, and a right direction of the vehicle 1. Note that the number of cameras 16 provided in the vehicle 1 is not limited to four.

The storage device 18 stores various pieces of data. In the present embodiment, the storage device 18 stores data such as the teacher route data D1 and the map data D2. Details of the teacher route data D1 and the map data D2 will be described later. The storage device 18 is, for example, an auxiliary storage device such as a hard disk drive (HDD), a solid state drive (SSD), or a flash memory.

The operation device 20 acquires a user's input operation. The operation device 20 is, for example, an input device such as a keyboard, a touch panel, or a switch. The operation device 20 is an example of a human machine interface (HMI).

The display device 22 is a display that displays various images. The display device 22 is installed at a position visually recognizable by a user who is an occupant of the vehicle 1. Examples of the display include a liquid crystal display (LCD), an organic electo-luminescence (EL) display, and a projector. The display may be a touch panel display in which the display device 22 and the operation device 20 are integrally configured. The display device 22 is an example of the HMI.

The display device 22 is not limited to one including only one display region. For example, the display device 22 may include a plurality of display regions. In addition, the vehicle 1 may include a plurality of display devices 22.

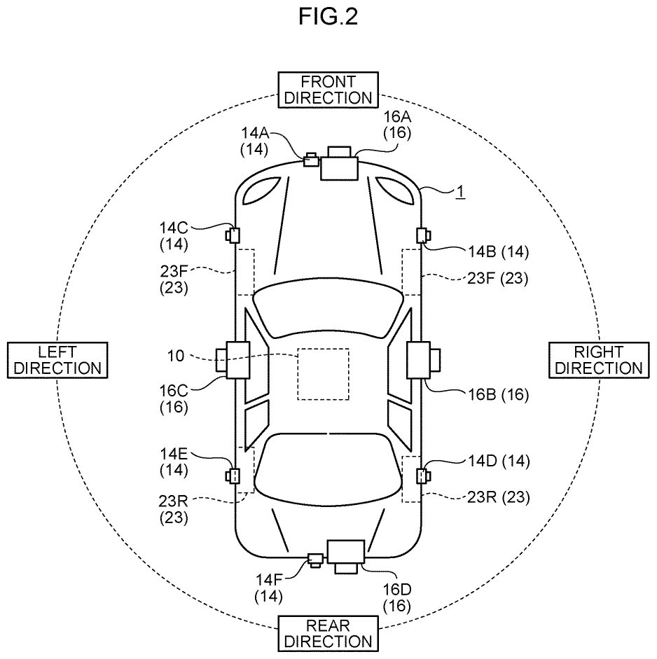

FIG. 2 is an explanatory diagram of an example of arrangement of the sensor 14 and the camera 16.

The vehicle 1 is provided with, for example, four cameras 16 (cameras 16A to 16D) so as to be able to acquire a situation outside the vehicle 1B in at least four directions of the front direction, the rear direction, the right direction, and the left direction of the vehicle 1, for example.

Specifically, for example, the camera 16 includes a camera 16A, a camera 16B, a camera 16C, and a camera 16D. The camera 16A is disposed at the front portion of the vehicle 1 and captures an image of an area in the front direction of the vehicle 1. The camera 16B is disposed at the right portion of the vehicle 1 and captures an image of an area in the right direction of the vehicle 1. The camera 16C is disposed at the left portion of the vehicle 1 and captures an image of an area in the left direction of the vehicle 1. The camera 16D is disposed at a rear portion of the vehicle 1 and captures an image of an area in the rear direction of the vehicle 1. Note that the number of cameras 16 provided in the vehicle 1 is not limited to four. In addition, regarding sensors that detect objects, such as a lidar, a radar, a sonar, and an ultrasonic sensor included in the sensor 14, it is preferable that the arrangement positions, the number of installations, and the like are adjusted in advance so that the external situations of regions in the right direction, in the left direction, in the front direction, and in the rear direction of the vehicle 1 can be acquired. For example, as illustrated in FIG. 2, the sensors 14 include sensors 14A to 14F. These sensors 14A to 14F are disposed at the vehicle 1 so as to be able to acquire external situations of regions in the right direction, in the left direction, in the front direction, and in the rear direction of the vehicle 1B. Note that the sensor 14 that detects an object, such as a lidar, a radar, a sonar, or an ultrasonic sensor, may be disposed only at the rear portion of the vehicle 1.

Next, a configuration of the vehicle 1 will be described.

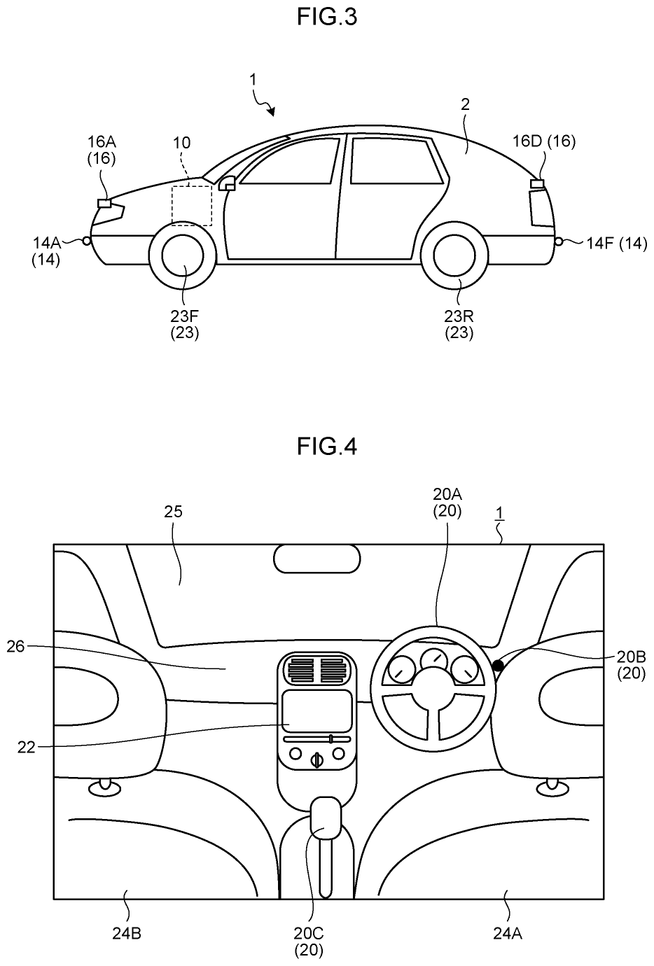

FIG. 3 is a schematic diagram illustrating an example of an external configuration of vehicle 1.

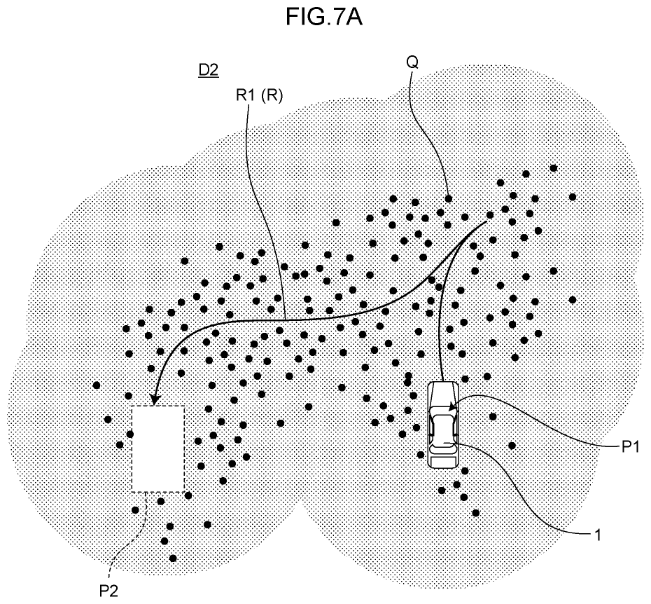

The vehicle 1 includes a vehicle body 2 and two pairs of wheels 23 disposed at the vehicle body 2 along a predetermined direction. The two pairs of wheels 23 include a pair of front tires 23F and a pair of rear tires 23R (see also FIG. 6). FIGS. 2 and 3 illustrate an example in which the vehicle 1 includes four wheels 23. However, the number of wheels 23 provided at the vehicle 1 is not limited thereto.

Next, a configuration in the vicinity of the driver seat of the vehicle 1 of the present embodiment will be described.

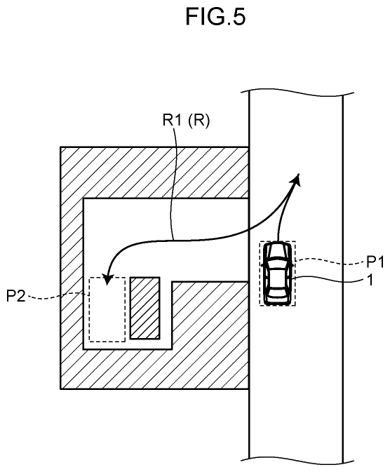

FIG. 4 is a diagram illustrating an example of a configuration in the vicinity of a driver seat 24A of the vehicle 1 of the present embodiment.

The vehicle 1 includes a driver seat 24A and a passenger seat 24B. A windshield 25, a dashboard 26, a steering wheel (steering operation unit) 20A, an operation button 20B, and a display device 22 are provided in the front direction of the driver seat 24A. A shift lever 20C, which is a lever for shifting the transmission, is provided near the driver seat 24A.

The steering wheel 20A, the operation button 20B, and the shift lever 20C are an example of the operation device 20.

The steering wheel 20A is provided in front of the driver seat 24A and can be operated by an occupant. The rotation angle of the steering wheel 20A, that is, the steering angle, is electrically or mechanically interlocked with the change in the direction of the front tire 23F, which is a steer wheel. The steer wheel may be the rear tire 23R, or both the front tire 23F and the rear tire 23R may be the steer wheels.

The operation button 20B is a button capable of receiving an operation by the occupant. The operation button 20B may include a direction indicator. The position of the operation button 20B is not limited to the example illustrated in FIG. 4, and may be provided, for example, at the steering wheel 20A. Although one operation button 20B is illustrated in FIG. 4, a plurality of operation buttons 20B may be provided. In a case where the display device 22 also serves as a touch panel, the display device 22 may be an example of the operation device 20.

Returning to FIG. 1, the description will be continued.

The vehicle control device 10 is an electronic control unit that integrally controls each unit of the vehicle 1.

The vehicle control device 10 controls the movement control device 12 so that the traveling state of the vehicle 1 is optimized using the sensor information, the video of the surroundings, and the like received from the sensor 14 and the camera 16, respectively. In addition, the vehicle control device 10 controls the movement control device 12 to cause the vehicle 1 to autonomously travel.

The vehicle control device 10 includes a control unit 11. Part or all of the control unit 11 may have a software configuration realized by cooperation of a processor and various programs stored in a memory. In addition, part or all of the control unit 11 may have a hardware configuration realized by a dedicated circuit or the like.

The control unit 11 integrally controls each unit of the vehicle 1.

In the present embodiment, the control unit 11 is configured to be able to switch the traveling mode to the teacher traveling mode or the autonomous traveling mode based on an input operation or the like on the operation device 20 by the user. The traveling mode executable by the vehicle 1 may include various traveling modes other than the teacher traveling mode and the autonomous traveling mode.

The teacher traveling mode is a mode for registering a teacher route when the vehicle 1 autonomously travels. The teacher route is a route obtained by teacher traveling from a predetermined position to a parking target position. In the teacher traveling mode, the vehicle 1 is controlled to travel by the driving operation by the user. That is, in the teacher traveling mode, the control unit 11 controls the movement control device 12 to travel according to the driving operation by the user.

The autonomous traveling mode is a mode in which the vehicle 1 autonomously travels. In the present embodiment, the autonomous traveling mode means a mode in which the vehicle 1 autonomously travels along the teacher route. In the autonomous traveling mode, the control unit 11 controls at least steering to control the movement control device 12 to travel along the teacher route. In the autonomous traveling mode, the vehicle 1 is automatically controlled to travel by the vehicle control device 10 without the driving operation by the user.

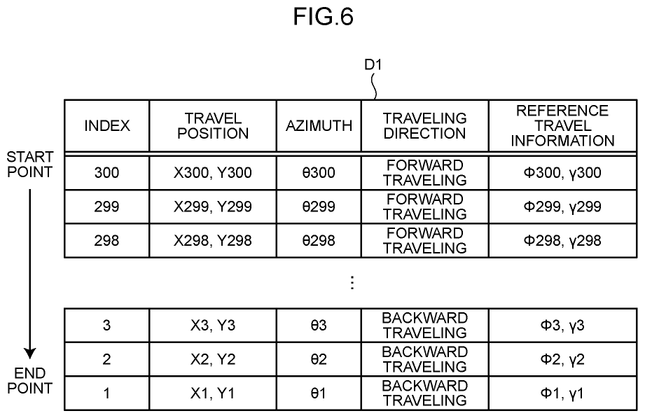

FIG. 5 is an explanatory diagram of an example of a teacher route R1.

In the teacher traveling mode, the teacher traveling from a predetermined position P1 to a parking target position P2 is performed by the driving operation by the user. The parking target position P2 is, for example, a parking lot or the like, but is not limited thereto. Further, the predetermined position P1 may be any position of the user in real space.

The travel route R traveled by the teacher traveling is treated as the teacher route R1, and the teacher route data D1 of the teacher route R1 is stored in the storage device 18. At the time of teacher traveling, the user may perform driving operation so that the vehicle travels from the parking target position P2 toward the predetermined position P1, or may perform driving operation so that the vehicle travels from the predetermined position P1 toward the parking target position P2. In a case where the vehicle 1 travels from the parking target position P2 toward the predetermined position P1 in the teacher traveling mode, the control unit 11 may create the teacher route data D1 of the teacher route R1 in which the traveling direction of the travel route R at the time of teacher traveling is set to the reverse direction. In a case where the vehicle 1 travels from the predetermined position P1 toward the parking target position P2 at the time of teacher traveling, the control unit 11 may create the teacher route data D1 of the teacher route R1 along the traveling direction of the travel route R at the time of teacher traveling. Details of the creation of the teacher route data D1 will be described later.

In the autonomous traveling mode, the control unit 11 causes the vehicle 1 to autonomously travel to the parking target position P2 by controlling at least steering along the travel route R obtained by the teacher traveling. In the autonomous traveling mode, the control unit 11 executes steering control and front and rear acceleration/deceleration control of the vehicle 1, but at least part of the front and rear acceleration/deceleration control may be executed by a driver's operation.

Next, control by the control unit 11 in each of the teacher traveling mode and the autonomous traveling mode will be described in detail.

### In Teacher Traveling Mode

First, the control of the control unit 11 in the teacher traveling mode will be described in detail.

When receiving a signal indicating an instruction to start the teacher traveling mode by the operation of the operation device 20 by the user or the like, the control unit 11 switches the traveling mode to the teacher traveling mode. Then, the control unit 11 executes the following process in the teacher traveling mode.

The control unit 11 acquires sensor information indicating the traveling state of the vehicle 1 from the sensor 14. Then, the control unit 11 estimates the current position of the vehicle 1 based on a temporal change in the sensor value indicated by the sensor information. For example, the control unit 11 calculates a movement amount of the vehicle 1 from a reference position such as a traveling start position when the teacher traveling mode is started based on a temporal change in the vehicle speed and the yaw rate represented by the sensor values, and estimates the current position of the vehicle 1 based on the movement amount.

Note that the estimation accuracy of the current position based on the movement amount may be low. Therefore, the control unit 11 may use a result of correcting the estimated current position as the current position based on the video of the surroundings around the vehicle 1 acquired by the camera 16.

The control unit 11 sequentially stores the current position of the vehicle 1 sequentially estimated along the travel of the vehicle 1 in the storage device 18. Specifically, the control unit 11 sets, as a teacher route R1, a travel route R at the time of teacher traveling represented by a group of current positions sequentially estimated from a time point when an instruction to start the teacher traveling mode is received until an instruction to end the teacher mode is received, and stores teacher route data D1 representing the teacher route R1 in the storage device 18.

FIG. 6 is a diagram illustrating an example of a data configuration of the teacher route data D1.

The teacher route data D1 includes a group of pieces of travel information for each position which is a current position sequentially estimated at the time of teacher traveling. The travel information includes an INDEX, a travel position, an azimuth, a traveling direction, and reference travel information. INDEX is identification information of travel information. The travel position is the estimated position of the vehicle 1. The azimuth indicates a direction of the vehicle 1 at the position. The traveling direction indicates a traveling direction of the vehicle 1 at the position, and is represented by, for example, forward traveling or backward traveling. The reference travel information is information indicating a traveling state or the like at the position. The reference travel information is, for example, information such as a steering angle and a vehicle speed detected at each position at the time of teacher traveling.

In addition, at the time of teacher traveling of the vehicle 1, the control unit 11 creates the map data D2 for estimating the current position of the vehicle 1 from the video of the surroundings captured by the camera 16. As a method of estimating the current position of the vehicle 1 from the video of the surroundings, a simultaneous localization and mapping (SLAM) method or the like is used.

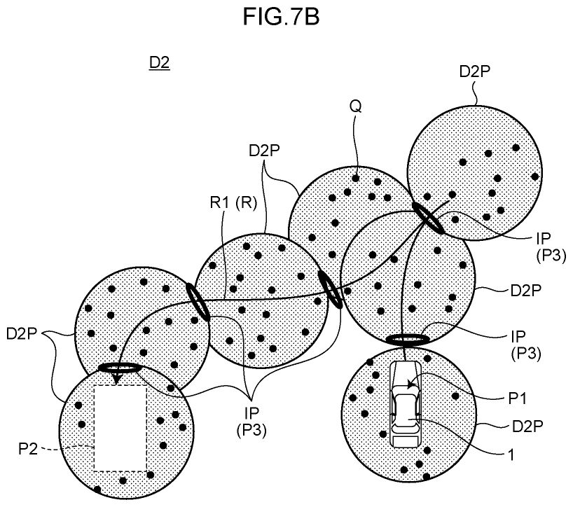

FIG. 7A is a schematic diagram of an example of the map data D2. FIG. 7A illustrates, in a bird's-eye view, a position in real space of the feature point Q in the real view stored in the map data D2.

The map data D2 is map data in which a plurality of feature points Q around the vehicle 1 at the time of traveling along the teacher route R1 is registered.

The feature point Q is a feature point obtained by performing image analysis on a captured image captured by the camera 16 at the time of teacher traveling. For example, the feature point Q is a portion where a characteristic image pattern can be obtained by analyzing the captured image of an object (for example, a tree, a wall, a column, or the like) or the like that can be a mark in the real view. The portion is, for example, an edge portion of the object. The map data D2 includes a plurality of feature points Q, and each feature point Q is identifiably registered for each feature point Q by being assigned an identification number.

The feature point Q is represented by feature point data including a three-dimensional position and a feature value.

The three-dimensional position of the feature point Q is a three-dimensional position of the feature point Q in real space, and is represented by, for example, a three-dimensional orthogonal coordinate system (X, Y, Z).

The feature value of the feature point Q is a characteristic amount of the feature point Q represented by image analysis of the captured image. The feature value of the feature point Q is, for example, luminance and density on the captured image, a scale invariant feature transform (SIFT) feature value, a speeded up robust features (SURF) feature value, or the like.

In the map data D2, one feature point Q is registered for each identical three-dimensional position. Note that, for the same three-dimensional position, a plurality of feature points Q may be registered in the map data D2 for each imaging position and imaging direction of the camera 16 at the three-dimensional position. In addition, the feature point data of the feature point Q registered in the map data D2 may further include image data of an object having the feature point Q.

At the time of teacher traveling, the control unit 11 identifies coordinates of the feature point Q in the real view based on, for example, stereo photogrammetry. Specifically, the control unit 11 reads a plurality of captured images captured at different timings, and associates the same feature point Q commonly appearing in the plurality of captured images. Then, for example, the control unit 11 estimates the temporary position of the vehicle 1 when the plurality of captured images is captured, and identifies the temporary coordinates of the feature point Q in the real view by the principle of triangulation. Then, for example, the control unit 11 performs bundle adjustment using the temporary position of the vehicle 1 and the temporary coordinates of the feature point Q in the real view as reference information, and calculates the formal position of the vehicle 1 and the formal coordinates of the feature point Q in the real view so as to minimize a reprojection error when each feature point Q in the real view is projected on all the captured images. Then, the control unit 11 stores, in the storage device 18, the map data D2 in which the feature point Q represented by the feature point data including the formal coordinates of the feature point Q in the real view as the three-dimensional position is registered.

The three-dimensional position of the feature point Q registered in the map data D2 may be a position measured in advance using light detection and ranging (LiDAR) or a stereo camera without using the SLAM method. However, from the viewpoint of suppressing a decrease in position estimation accuracy, it is preferable to use the SLAM method.

Note that, as illustrated in FIG. 7A, the control unit 11 may generate one piece of map data D2 including the entire teacher route R1, but may create, as the map data D2, a plurality of pieces of partial map data at least partially non-overlapping with each other along the teacher route R1.

FIG. 7B is a schematic diagram of an example of the map data D2. FIG. 7B illustrates, in a bird's-eye view, a position in real space of the feature point Q in the real view stored in the map data D2.

As illustrated in FIG. 7B, the map data D2 may include a plurality of pieces of partial map data D2P at least partially non-overlapping with each other along the teacher route R1. The feature point data of the feature point Q may be registered in each partial map data D2P in the same manner as described above.

Since the map data D2 includes the plurality of pieces of partial map data D2P, the data capacity of the map data D2 can be reduced as compared with a case where one map data D2 including the entire teacher route R1 is created.

As described above, the control unit 11 executes the above processing in the teacher traveling mode. For this reason, in the teacher traveling mode, the control unit 11 generates the teacher route data D1 of the teacher route R1 obtained by the teacher traveling from the predetermined position P1 to the parking target position P2, and the map data D2 in which the three-dimensional position of each of the plurality of feature points Q around the vehicle 1 during the travel along the teacher route R1 and the feature values of the feature points Q are registered, and stores the generated data in the storage device 18.

### In Autonomous Traveling Mode

Next, the control of the control unit 11 in the autonomous traveling mode will be described in detail.

The control unit 11 switches the traveling mode to the autonomous traveling mode when receiving a signal indicating an instruction to start the autonomous traveling mode by the operation of the operation device 20 by the user. Then, the control unit 11 executes the following process in the autonomous traveling mode.

The control unit 11 reads the teacher route data D1 and the map data D2 from the storage device 18, and controls the movement control device 12 to perform autonomous traveling along the teacher route R1 represented by the teacher route data D1.

The control unit 11 estimates the current position of the vehicle 1 based on the map data D2 and the captured image around the vehicle 1 acquired by at least one camera 16.

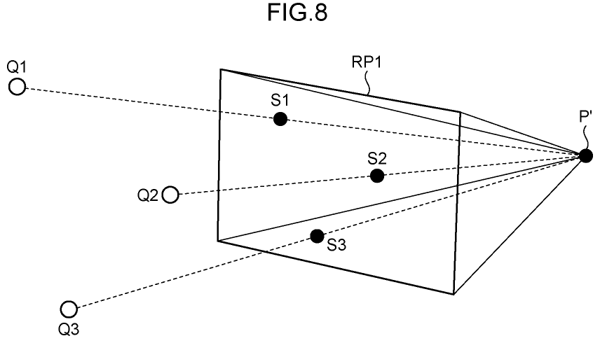

FIG. 8 is an explanatory diagram of an example of an estimation process of a current position of the vehicle 1, the estimation process being executed by a control unit 11 in an autonomous traveling mode.

In FIG. 8, S1, S2, and S3 represent three feature points extracted from the captured image captured by the camera 16, and points Q1, Q2, and Q3 are feature points Q stored in the map data D2, and represent three-dimensional positions of the feature points S1, S2, and S3 in real space. RP1 represents an imaging plane of the camera 16. The point P′ represents the position (that is, the position of the vehicle 1) of the camera 16 obtained from the three feature points S1, S2, and S3 extracted from the captured image captured by the camera 16 and the feature points Q (Q1, Q2, Q3) stored in the map data D2.

For example, the control unit 11 first matches the feature point extracted from the captured image captured by the camera 16 with the feature point Q stored in the map data D2 using pattern matching, feature value search, or the like. Then, the control unit 11 randomly selects several (for example, three to six) feature points among the feature points that are extracted from the captured image captured by the camera 16 and can be matched with the feature point Q stored in the map data D2.

Then, the control unit 11 estimates the current position of the vehicle 1 in real space based on the positions of these several feature points in the captured image and the three-dimensional positions, in real space, of the feature points Q registered in the map data D2 corresponding to the several feature points. At this time, the control unit 11 estimates the current position of the vehicle 1 by solving the PnP problem using, for example, a known method (for example, the document: Mikael Persson et al. “Lambda Twist: An Accurate Fast Robust Perspective Three Point (P3P) Solver”, ECCV 2018, pp 334-349, published in 2018, http://openaccess.thecvf.com/content_ECCV_2018/papers/Mikael_Persson_Lambda_Twist_An_ECCV_2018_paper.pdf) such as Lambda Twist.

When matching the feature point extracted from the captured image captured by the camera 16 with the feature point Q stored in the map data D2, the control unit 11 may calculate the current position of the vehicle 1 as a temporary position based on the movement amount of the vehicle 1 described above, for example, and may narrow down the feature point Q to be matched with the feature point extracted from the captured image captured by the camera 16 among the feature points Q stored in the map data D2 with the temporary position as a reference.

Through these processes, the control unit 11 estimates current position information including information related to the two-dimensional position (X coordinate, Y coordinate) of the vehicle 1 in real space and the direction of the vehicle 1 as current position information indicating the current position of the vehicle 1 based on the map data D2 and the captured image around the vehicle 1, the captured image being acquired by at least one camera 16.

Then, the control unit 11 causes the vehicle 1 to autonomously travel from the predetermined position P1 toward the parking target position P2 along the teacher route R1 by controlling the movement control device 12 so that the estimated current position of the vehicle 1 is a position on the teacher route R1 represented by the teacher route data D1. Then, the control unit 11 stops the vehicle 1 at the parking target position P2.

When the vehicle 1 autonomously travels along the travel route R, the control unit 11 feedback-controls the movement control device 12 so that the vehicle 1 moves along the teacher route R1 based on the estimated current position of the vehicle 1 and each position on the teacher route R1 represented by the teacher route data D1.

Here, while the vehicle 1 autonomously travels from the predetermined position P1 to the parking target position P2 along the teacher route R1, an event such as manual operation by the user for avoiding an obstacle around the vehicle 1 may occur. In a case where such an event occurs, since the vehicle 1 is the first predetermined distance or more away from the teacher route R1, the position of the vehicle 1 with respect to the teacher route R1 cannot be estimated, and it is difficult to resume or continue the autonomous traveling.

The first predetermined distance is a distance between the vehicle 1 and the teacher route R1 to such an extent that it is difficult to estimate the current position of the vehicle 1 using the feature point extracted from the captured image captured by the camera 16 and the feature point Q registered in the map data D2. That is, when the vehicle 1 is the first predetermined distance or more away from the teacher route R1, the control unit 11 cannot estimate the position of the vehicle 1 with respect to the teacher route R1, that is, the current position of the vehicle 1 with respect to the teacher route R1 is lost.

Specifically, as described above, in estimating the current position of the vehicle 1 using the map data D2, the control unit 11 identifies N (N is an integer of 1 or more, for example, 7 or more) feature points extracted from the captured image captured by the camera 16 and successfully matched with the feature points Q stored in the map data D2, and randomly selects several (for example, 3 to 6) feature points among the identified points, thereby estimating the current position of the vehicle 1. In the control unit 11, in a case where the number of feature points extracted from the captured image captured by the camera 16 and matched with the feature points Q stored in the map data D2 is less than N, the control unit 11 loses the current position of the vehicle 1 with respect to the teacher route R1. As the first predetermined distance, a value equal to or larger than the lower limit of the distance between the vehicle 1 in the lost state and the teacher route R1 may be determined in advance. In addition, the first predetermined distance may be appropriately changeable by an operation or the like of the operation device 20 by the user within a range satisfying these conditions.

The control unit 11 determines whether the estimated current position of the vehicle 1 is the first predetermined distance or more away from the teacher route R1.

Specifically, the control unit 11 estimates the current position of the vehicle 1 based on the map data D2 and the captured image around the vehicle 1 acquired by the at least one camera 16, and determines whether the vehicle 1 is the first predetermined distance or more away from the teacher route R1 using the estimated current position of the vehicle 1. In this case, the control unit 11 determines whether the shortest distance between the estimated current position of the vehicle 1 and the teacher route R1 represented by the teacher route data D1 is greater than or equal to the first predetermined distance, thereby determining whether the current position of the vehicle 1 is the first predetermined distance or more away from the teacher route R1.

In addition, for example, the control unit 11 may determine whether the number of feature points that can be matched when matching them with the feature points Q stored in the map data D2 from among feature points extracted from the captured image captured by the camera is less than N, thereby determining whether the current position of the vehicle 1 is the first predetermined distance or more away from the teacher route R1.

In a case where it is determined that the estimated current position of the vehicle 1 is not the first predetermined distance or more away from the teacher route R1, the control unit 11 continues the process of controlling the movement control device 12 so that the vehicle autonomously travels along the teacher route R1.

On the other hand, in a case where it is determined that the estimated current position of the vehicle 1 is the first predetermined distance or more away from the teacher route R1, the control unit 11 displays, on the display device 22, the returnable position where the vehicle 1 is capable of returning to the teacher route R1, the returnable position being superimposed on the video of the surroundings.

Displaying the returnable position with the returnable position being superimposed on the video of the surroundings means at least one of displaying the returnable position on the video of the surroundings in a superimposed manner and displaying the returnable position simultaneously with the video of the surroundings at the temporally same timing.

The returnable position is a position on the teacher route R1 and a position where the vehicle 1 can returning on the teacher route R1.

For example, the returnable position is a position on a partial route that is linear for a second predetermined distance or more in the teacher route R1. The partial route is a partial route of the teacher route R1. The second predetermined distance may be any distance equal to or longer than a distance required for the vehicle 1 to return onto the teacher route R1 from a position the first predetermined distance or more away from the teacher route R1, and to be able to travel in a state where the entire length direction of the vehicle body of the vehicle 1 substantially coincides with the direction along the extension direction of the teacher route R1. Specifically, for example, the second predetermined distance may be any distance equal to or greater than one time or two times the entire length of the vehicle 1. The second predetermined distance may be changeable in accordance with an operation instruction or the like of the operation device 20 by the user within a range satisfying the above condition.

Further, the returnable position may be a position on a partial route having a predetermined curvature or less in the teacher route R1. The predetermined curvature may be any curvature equal to or less than a curvature required for the vehicle 1 to return to the teacher route R1 from the position the first predetermined distance or more away from the teacher route R1, and to be able to travel in a state in which the entire length direction of the vehicle body of the vehicle 1 substantially coincides with the direction along the extension direction of the teacher route R1.

The returnable position may be a position on the teacher route R1 a third predetermined distance or more away from the parking target position P2. The third predetermined distance may be any distance that enables parking assistance for the occupant by the vehicle 1 autonomously traveling from a position on the teacher route R1 the third predetermined distance away from the parking target position P2. Furthermore, the third predetermined distance may be appropriately changeable in accordance with an operation instruction or the like of the operation device 20 by the user within a range satisfying the above condition.

Further, the returnable position may be an entry position of the teacher route R1 in the partial map data D2P. In a case where the map data D2 including a plurality of pieces of partial map data D2P is used as the map data D2, it is possible to resume autonomous traveling using the feature point Q in the partial map data D2P. Therefore, the returnable position may be an entry position IP of the partial map data D2P. Specifically, as illustrated in FIG. 7B, the control unit 11 may set the entry position IP of the teacher route R1 in the partial map data D2P as a returnable position P3.

In addition, the returnable position may be a position closest to the estimated current position of the vehicle 1 on the teacher route R1.

The control unit 11 identifies, as the returnable position P3, any one, on the teacher route R1, of a position on a partial route that is linear for the second predetermined distance or more, a position on a partial route having the predetermined curvature or less, a position the third predetermined distance or more away from the parking target position P, an entry position IP of the teacher route R1 in the partial map data D2P, and a position closest to the estimated current position of the vehicle 1.

In addition, the control unit 11 may identify, as the returnable position P3, a position on the teacher route R1, the position satisfying two or more conditions of a position on the partial route that is linear for the second predetermined distance or more or a position on the partial route having the predetermined curvature or less, a position the third predetermined distance or more away from the parking target position P2, an entry position IP of the teacher route R1 in the partial map data D2P, and a position closest to the estimated current position of the vehicle 1.

Then, in a case where the vehicle 1 is the first predetermined distance or more away from the teacher route R1 while moving from the predetermined position P1 to the parking target position P2 along the teacher route R1, the control unit 11 displays, on the display device 22, the returnable position P3 where the vehicle 1 is capable of returning to the teacher route R1, the returnable position P3 being superimposed on the video of the surroundings.

Specifically, the control unit 11 displays, on the display device 22, the returnable position P3 and at least one of a text prompting a movement to the returnable position P3 and a text indicating that the vehicle is the first predetermined distance or more away from the teacher route R1, the returnable position P3 and the at least one of them being superimposed on the video of the surroundings.

Furthermore, the control unit 11 may display, on the display device, the video of the surroundings corresponding to the captured image acquired by at least one camera 16, and may display, on the display device 22, the returnable position P3 superimposed on the video of the surroundings. The video of the surroundings on which the returnable position P3 is to be superimposed and displayed may be either a video of the surroundings captured by the camera 16 in real time or a video of the surroundings captured in the past by the camera 16.

Furthermore, the control unit 11 may display the teacher route R1 and the returnable position P3 superimposed on the video of the surroundings. Furthermore, the control unit 11 may further display at least one of a text prompting a movement to the returnable position P3 and a text indicating that the vehicle is the first predetermined distance or more away from the teacher route R1, the at least one being superimposed on the video of the surroundings.

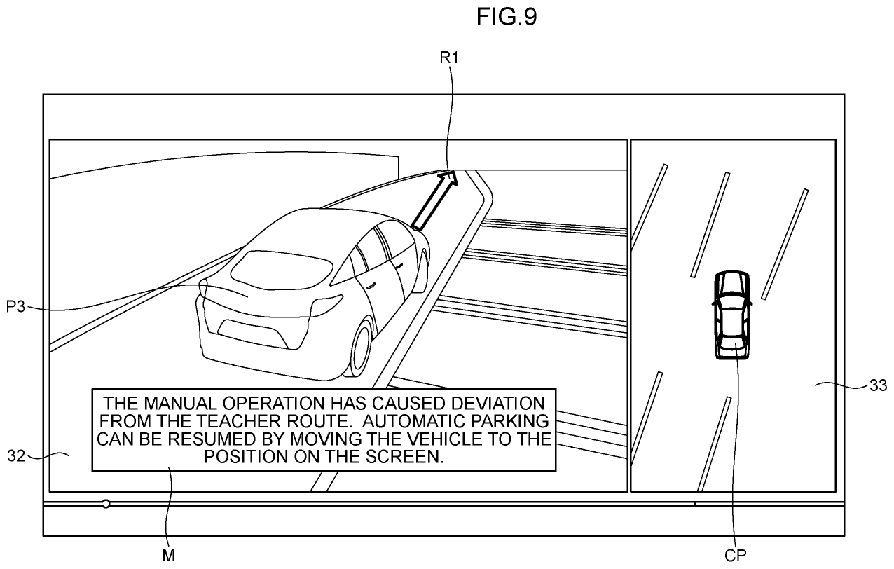

FIG. 9 is a schematic diagram of an example of a display screen 30.

For example, the control unit 11 displays, on the display device 22, the display screen 30 in a case where the vehicle 1 is the first predetermined distance or more away from the teacher route R1 while moving from the predetermined position P1 to the parking target position P2 along the teacher route R1.

The display screen 30 is, for example, a screen in which the returnable position P3, the teacher route R1, and the message M are displayed, with them being superimposed on the video of the surroundings 32. FIG. 9 illustrates an example in which the returnable position P3 is displayed by disposing an icon representing the vehicle 1 at the returnable position P3 on the video of the surroundings 32. In addition, FIG. 9 illustrates an example in which an arrow image representing the teacher route R1 is displayed, the arrow image being superimposed on the video of the surroundings 32. In addition, FIG. 9 illustrates an example in which a message M includes “automatic parking can be resumed by moving the vehicle to the position on the screen”, which is an example of the text prompting the movement to the returnable position P3, and “the manual operation has caused deviation from the teacher route” , which is an example of the text indicating that the vehicle is the first predetermined distance or more away from the teacher route R1.

In addition, the display screen 30 may further include a screen in which an icon CP representing the current position and the current orientation of the vehicle 1 is superimposed on the video of the surroundings 33.

Furthermore, the control unit 11 may further cause a speaker provided at the vehicle 1 to output a voice indicating the returnable position P3 and at least one of a text prompting a movement to the returnable position P3 and a text indicating that the vehicle is the first predetermined distance or more away from the teacher route R1.

In a case where the vehicle 1 is driven by the user who is an occupant of the vehicle 1 and moves to the returnable position P3 after the returnable position P3 is displayed on the display device 22, the control unit 11 resumes the autonomous traveling to the returnable position P3 along the teacher route R1.

Specifically, when receiving the driving operation of the vehicle 1 by the user after displaying the returnable position P3 on the display device 22, the control unit 11 cancels the autonomous traveling mode and controls the movement control device 12 so that the vehicle travels according to the driving operation by the user.

As described above, the returnable position P3 is displayed on the display device 22. Therefore, the driver of the vehicle 1 performs a driving operation while visually recognizing the returnable position P3 displayed on the display device 22, thereby easily moving the vehicle 1 to the returnable position P3 and allowing the vehicle 1 to resume autonomous traveling.

Then, the control unit 11 estimates the current position of the vehicle 1 in the same manner as described above, and resumes the autonomous traveling when an instruction to start the automatic traveling mode is received by an operation instruction or the like of the operation device 20 by the user after determining that the vehicle 1 has moved to the returnable position P3. Then, the control unit 11 controls the movement control device 12 so that the vehicle autonomously travels along the teacher route R1 until reaching the parking target position P2.

Next, an example of a flow of information processing executed by the control unit 11 of the vehicle control device 10 will be described.

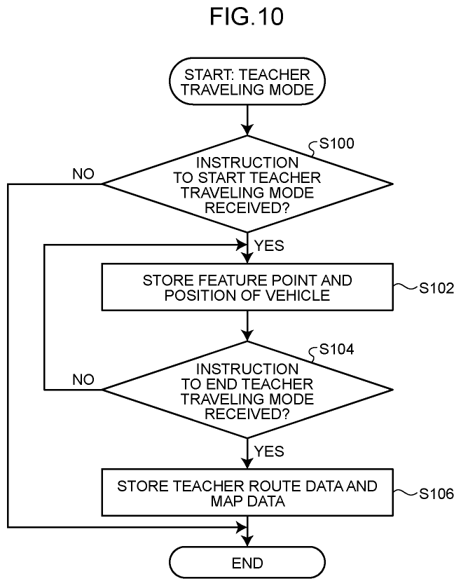

FIG. 10 is a flowchart illustrating an example of a flow of information processing executed by the control unit 11 in the teacher traveling mode.

The control unit 11 determines whether a signal indicating an instruction to start the teacher traveling mode has been received from the operation device 20 (Step S100). When a negative determination is made in Step S100 (Step S100: No), this routine ends. When an affirmative determination is made in Step S100 (Step S100: Yes), the process proceeds to Step S102.

When the teacher traveling of the vehicle 1 is started by the driving operation of the vehicle 1 by the user, the control unit 11 sequentially stores the map data D2 and the current position of the vehicle 1 in the storage device 18 (Step S102). Specifically, the control unit 11 sequentially stores the current position of the vehicle 1 sequentially estimated along the teacher traveling of the vehicle 1. At this time, the control unit 11 assigns an INDEX to the current position, and sequentially stores the travel position which is a current position, the azimuth, the traveling direction, and the reference travel information in association with each other. In addition, the control unit 11 identifies feature point Q by performing image analysis on captured images captured by the camera 16 at the time of teacher traveling, and sequentially registers the feature point Q in the map data D2.

The control unit 11 determines whether an instruction to end the teacher traveling mode has been received (Step S104). The control unit 11 determines whether a signal indicating the end instruction has been received from the operation device 20 according to the operation by the user, thereby making the determination in Step S104. When the control unit 11 makes a negative determination in Step S104 (Step S104: No), the process returns to Step S102. When the control unit 11 makes an affirmative determination in Step S104 (Step S104: Yes), the process proceeds to Step S106.

In Step S106, the control unit 11 stores the teacher route data D1 and the map data D2 in the storage device 18 (Step S106). The control unit 11 sets, as a teacher route R1, the travel route R at the time of teacher traveling represented by the group of sequentially estimated current positions stored in the process of Step S102, and stores teacher route data D1 representing the teacher route R1 in the storage device 18. In addition, the control unit 11 stores, in the storage device 18, the map data D2 in which the feature points Q identified by the process in Step S102 are registered. Then, this routine ends.

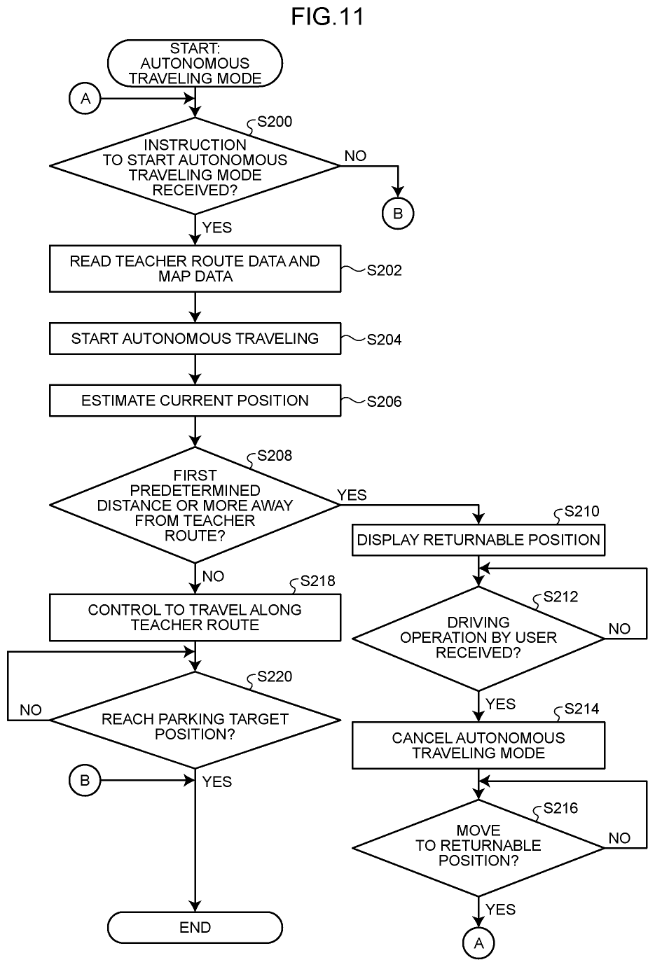

FIG. 11 is a flowchart illustrating an example of a flow of information processing executed by the control unit 11 in the autonomous traveling mode.

The control unit 11 determines whether a signal indicating an instruction to start the autonomous traveling mode has been received (Step S200). The control unit 11 determines whether a signal indicating an instruction to start the autonomous traveling mode has been received from the operation device 20, thereby making the determination in Step S200. When a negative determination is made in Step S200 (Step S200: No), this routine ends. When an affirmative determination is made in Step S200 (Step S200: Yes), the process proceeds to Step S202.

In Step S202, the control unit 11 reads the teacher route data D1 and the map data D2 from the storage device 18 (Step S202). Then, the control unit 11 starts autonomous traveling along the teacher route R1 by controlling the movement control device 12 so that the vehicle performs autonomous traveling along the teacher route R1 represented by the teacher route data D1 (Step S204).

Then, the control unit 11 estimates the current position of the vehicle 1 based on the map data D2 and the captured image around the vehicle 1, the captured image being acquired by at least one camera 16 (Step S206).

Then, the control unit 11 determines whether the current position, of the vehicle 1, estimated in Step S206 is a first predetermined distance or more away from the teacher route R1 (Step S208). When an affirmative determination is made in Step S208 (Step S208: Yes), the process proceeds to Step S210.

In Step S210, the control unit 11 displays, on the display device 22, the returnable position P3 where returning to the teacher route R1 is possible (Step S210).

A user who is a driver of the vehicle 1 starts a driving operation of the vehicle 1 so that the vehicle 1 reaches the returnable position P3 while the user visually recognizes the returnable position P3 displayed on the display device 22.

Next, the control unit 11 repeats the negative determination (Step S212: No) until it is determined that the driving operation of vehicle 1 by the user has been received (Step S212: Yes). When the control unit 11 makes an affirmative determination in Step S212 (Step S212: Yes), the process proceeds to Step S214. In Step S214, the control unit 11 cancels the autonomous traveling mode (Step S214).

By the process of Step S214, the driving operation by the user who is the driver of the vehicle 1 is possible, and the user performs the driving operation of the vehicle 1 so that the vehicle 1 reaches the returnable position P3 while the user visually recognizes the returnable position P3 displayed on the display device 22. The control unit 11 controls the movement control device 12 so that the vehicle travels in accordance with a driving operation by the user.

The control unit 11 estimates the current position of the vehicle 1 in the same manner as in Step S206, and determines whether the vehicle 1 has moved to the returnable position P3 (Step S216). The control unit 11 repeats the negative determination (Step S216: No) until an affirmative determination is made in Step S216 (Step S216: Yes). When the control unit 11 makes an affirmative determination in Step S216 (Step S216: Yes), the process returns to Step S200.

On the other hand, when a negative determination is made in Step S208 (Step S208: No), the process proceeds to Step S218. In Step S218, the control unit 11 causes the vehicle 1 to autonomously travel from the predetermined position P1 toward the parking target position P2 along the teacher route R1 by controlling the movement control device 12 so that the current position of the vehicle 1 estimated in Step S206 is a position on the teacher route R1 represented by the teacher route data D1 (Step S218). Then, the control unit 11 repeats the negative determination (Step S220: No) until it is determined that the vehicle 1 has reached the parking target position P2 (Step S220: Yes). When an affirmative determination is made in Step S220 (Step S220: Yes), the control unit 11 controls the movement control device 12 to stop the vehicle 1 at the parking target position P2, and this routine ends.

As described above, the vehicle control device 10 of the present embodiment is mounted on the vehicle 1 including the camera 16 that acquires the video of the surroundings, the display device 22 that can be visually recognized by the occupant of the vehicle 1, and the movement control device 12 that controls at least steering. The vehicle control device 10 causes the movement control device 12 to control the at least steering along the teacher route R1 obtained by the teacher traveling from the predetermined position P1 to the parking target position P2, and causes the vehicle 1 to autonomously travel to the parking target position P2. The vehicle control device 10 displays, on the display device 22, the video of the surroundings acquired by the camera 16. In a case where the vehicle 1 is a first predetermined distance or more away from the teacher route R1 while moving from the predetermined position P1 to the parking target position P2 along the teacher route R1, the vehicle control device 10 displays, on the display device 22, the returnable position P3 where the vehicle 1 is capable of returning to the teacher route R1, the returnable position P3 being superimposed on the video of the surroundings.

As described above, in a case where the vehicle 1 is the first predetermined distance or more away from the teacher route R1 while moving from the predetermined position P1 to the parking target position P2 along the teacher route R1, the vehicle control device 10 of the present embodiment displays, on the display device 22, the returnable position P3 where the vehicle 1 is capable of returning to the teacher route R1, the returnable position P3 being superimposed on the video of the surroundings.

Therefore, when the vehicle control device 10 of the present embodiment cannot estimate the position of the vehicle 1 with respect to the teacher route R1, the vehicle being the first predetermined distance or more away from the teacher route R1, that is, when the current position of the vehicle 1 with respect to the teacher route R1 is lost, the vehicle control device 10 displays the returnable position P3 on the display device 22. Therefore, the driver of the vehicle 1 performs a driving operation while visually recognizing the returnable position P3 displayed on the display device 22, thereby easily moving the vehicle 1 to the returnable position P3 and allowing the vehicle 1 to resume autonomous traveling.

Therefore, the vehicle control device 10 of the present embodiment can provide more suitable parking assistance.

Next, a hardware configuration of the vehicle control device 10 of the present embodiment will be described.

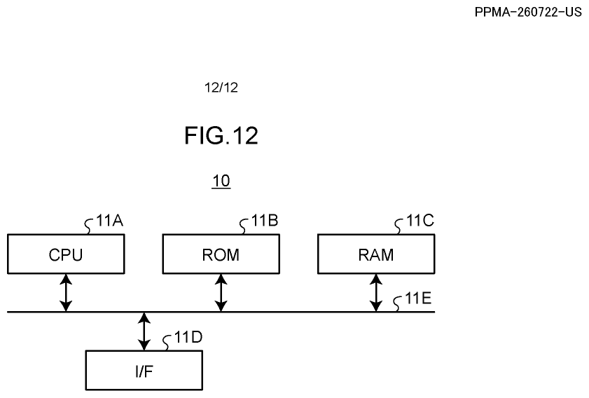

FIG. 12 is a block diagram illustrating a hardware configuration example of the vehicle control device 10.

The vehicle control device 10 has a hardware configuration using a normal computer in which a central processing unit (CPU) 11A, a read only memory (ROM) 11B, a random access memory (RAM) 11C, an I/F 11D for being connected to various devices, and the like are connected to each other by a bus 11E.

The CPU 11A is an arithmetic device that controls the entire processing of the vehicle control device 10. The RAM 11C stores data necessary for various processes by the CPU 11A. The ROM 11B stores programs and the like for realizing various processes by the CPU 11A. The I/F 11D is an interface that is connected to an external device or an external terminal via a communication line or the like to transmit and receive data to and from the connected external device or external terminal.

The program for executing the above-described various processes executed by the vehicle control device 10 is provided by being incorporated in the ROM 11B or the like in advance. The program for executing the vehicle control method executed in the present embodiment may be provided by being recorded in a computer-readable recording medium such as a CD-ROM, a flexible disc (FD), a CD-R, or a digital versatile disc (DVD) as a file in a format installable or executable in these devices.

In addition, the program for executing the vehicle control method executed in the present embodiment may be stored in a computer connected to a network such as the Internet and provided by being downloaded via the network. In addition, the program for executing the vehicle control method executed in the present embodiment may be provided or distributed via a network such as the Internet.

According to the vehicle control method according to the present disclosure, more suitable parking assistance can be provided.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method executed by a vehicle control device mounted on a vehicle including: a camera configured to acquire a video of surroundings, a display device configured to be visually recognized by an occupant, and a movement control device configured to control at least steering, the method comprising:
causing the movement control device to control at least steering to cause the vehicle to autonomously travel to a parking target position along a teacher route obtained by teacher traveling from a predetermined position to the parking target position;
displaying, on the display device, the video of the surroundings acquired by the camera; and
displaying, on the display device, a returnable position where returning to the teacher route is possible, the returnable position being superimposed on the video of the surroundings, in a case where the vehicle is a first predetermined distance or more away from the teacher route while moving from the predetermined position to the parking target position along the teacher route.

2. The vehicle control method according to claim 1, wherein
the vehicle further includes an operation device configured to receive an operation of an occupant, and
the method includes resuming autonomous traveling to the parking target position along the teacher route in a case where the occupant operates the operation device to move the vehicle to the returnable position after displaying, on the display device, the returnable position superimposed on the video of the surroundings.

3. The vehicle control method according to claim 1, comprising:
displaying, on the display device, together with the video of the surroundings, the returnable position where returning to the teacher route is possible and a text prompting a movement to the returnable position, in a case where the vehicle is the first predetermined distance or more away from the teacher route.

4. The vehicle control method according to claim 1, comprising:
displaying, on the display device, together with the video of the surroundings, the returnable position where returning to the teacher route is possible and a text indicating that the vehicle is the first predetermined distance or more away from the teacher route, in a case where the vehicle is the first predetermined distance or more away from the teacher route.

5. The vehicle control method according to claim 1, comprising:
displaying, on the display device, a returnable position where returning to the teacher route is possible and the teacher route, the returnable position and the teacher route being superimposed on the video of the surroundings, in a case where the vehicle is the first predetermined distance or more away from the teacher route while the vehicle is moving from the predetermined position to the parking target position along the teacher route.

6. The vehicle control method according to claim 1, comprising:
estimating a current position of the vehicle based on map data in which a three-dimensional position of each of a plurality of feature points around the vehicle during traveling along the teacher route, and feature values of the feature points are registered, and a captured image around the vehicle acquired by at least one camera; and
determining, from the current position of the vehicle, that the vehicle is the first predetermined distance or more away from the teacher route.

7. The vehicle control method according to claim 1, wherein the returnable position includes a position on a partial route that is linear for a second predetermined distance or more in the teacher route.

8. The vehicle control method according to claim 1, wherein the returnable position includes a position on a partial route having a predetermined curvature or less in the teacher route.

9. The vehicle control method according to claim 1, wherein the returnable position includes a position that is a third predetermined distance or more away from the parking target position in the teacher route.

10. A vehicle control device mounted on a vehicle including:
a camera configured to acquire a video of surroundings; a display device configured to be visually recognized by an occupant; and a movement control device configured to control at least steering, and configured to cause the movement control device to control the at least steering along a teacher route obtained by teacher traveling from a predetermined position to a parking target position, and cause the vehicle to autonomously travel to the parking target position, the vehicle control device is configured to:
display, on the display device, the video of the surroundings acquired by the camera; and
display, on the display device, a returnable position where returning to the teacher route is possible, the returnable position being superimposed on the video of the surroundings, in a case where the vehicle is a first predetermined distance or more away from the teacher route while the vehicle is moving from the predetermined position to the parking target position along the teacher route.

11. The vehicle control device according to claim 10, wherein
the vehicle further includes an operation device configured to receive an operation of an occupant, and
the vehicle control device is configured to resume the autonomous traveling to the parking target position along the teacher route in a case where the occupant operates the operation device to move the vehicle to the returnable position after displaying, on the display device, the returnable position superimposed on the video of the surroundings.

12. The vehicle control device according to claim 10, wherein the vehicle control device is configured to display, on the display device, together with the video of the surroundings, the returnable position where returning to the teacher route is possible and a text prompting a movement to the returnable position, in a case where the vehicle is the first predetermined distance or more away from the teacher route.

13. The vehicle control device according to claim 10, wherein the vehicle control device is configured to display, on the display device, together with the video of the surroundings, the returnable position where returning to the teacher route is possible and a text indicating that the vehicle is the first predetermined distance or more away from the teacher route, in a case where the vehicle is the first predetermined distance or more away from the teacher route.

14. The vehicle control device according to claim 10, wherein the vehicle control device is configured to display, on the display device, a returnable position where returning to the teacher route is possible and the teacher route, the returnable position and the teacher route being superimposed on the video of the surroundings, in a case where the vehicle is the first predetermined distance or more away from the teacher route while the vehicle is moving from the predetermined position to the parking target position along the teacher route.

15. The vehicle control device according to claim 10, wherein the vehicle control device is configured to:
estimate a current position of the vehicle based on map data in which a three-dimensional position of each of a plurality of feature points around the vehicle during traveling along the teacher route, and feature values of the feature points are registered, and a captured image around the vehicle acquired by at least one camera; and
determine, from the current position of the vehicle, that the vehicle is the first predetermined distance or more away from the teacher route.

16. The vehicle control device according to claim 10, wherein the returnable position includes a position on a partial route that is linear for a second predetermined distance or more in the teacher route.

17. The vehicle control device according to claim 10, wherein the returnable position includes a position on a partial route having a predetermined curvature or less in the teacher route.

18. The vehicle control device according to claim 10, wherein the returnable position includes a position that is a third predetermined distance or more away from the parking target position in the teacher route.
